(19) United States
(12) Patent Application Publication
(10) Pub. No.: US 2010/0206070 A1
(43) Pub. Date: Aug. 19, 2010

(54) SPEED METER HAVING PEDOMETRIC FUNCTION

(76) Inventors: Yung-Hung CHIH, Shulin City (TW); Ching-Wen Yeh, Shulin City (TW)

Correspondence Address: Muncy, Geissler, Olds & Lowe, PLLC, 4000 Legato Road, Suite 310, FAIRFAX, VA, 22033, US

(21) Appl. No.: 12/372,508

(22) Filed: Feb. 17, 2009

(51) Int. Cl. G01P 15/00

(52) U.S. Cl. 73/495

(57) ABSTRACT

A speed meter having pedometric function comprises a casing provided with a liquid crystal screen, a gravity sensor provided in electric connection in the casing, a circuit board, and a microprocessor. A changeover switch is respectively connected with the gravity sensor and the microprocessor. Thereby, the forward speed of a vehicle can be obtained by the detection of the gravity sensor and the calculation of the microprocessor when the vehicle is driven. After the changeover switch is switched into a status of walking or running, the step count of a user can be obtained by the detection of the gravity sensor and the calculation of the microprocessor and shown on the liquid crystal screen.

### TECHNICAL FIELD

The present invention relates to a speed meter having pedometric function and, more particularly, to a speed meter having pedometric function where the forward acceleration of a vehicle (such as a car, bicycle, motorcycle, or a three-wheeler) or the vibration of the human body of a user moving forward is detected by a gravity sensor and then the forward speed of the vehicle or the step count of the user is obtained by the calculation of the microprocessor.

### BACKGROUND

Speed meters are able to detect the speed of cars, motorcycles, or other vehicles to provide recent speed to drivers or riders in order to escape potential risk resulted from driving or riding vehicles too fast. Therefore, speed meters are widely used in various vehicles, such as cars, three-wheelers, motorcycles, and bicycles.

Among various vehicles, the speed meters used in bicycles are exemplified hereinafter. Each of these speed meters mainly comprises a signal emitter, a signal receiver, a calculation unit, and a display. The signal emitter is fixed at the spoke of a wheel. The signal receiver is fixed at one side of the chain stay and connected with a microprocessor via a connecting wire. Thereby, when a drivers or rider drives or rides a vehicle and keep the wheel together with the signal emitter moving circularly, the signal receiver executes detection repeatedly and the speed of the vehicle can be obtained via the calculation of the microprocessor and shown on the display.

However, a more complicated assembly is required because the signal emitter and the signal receiver are fixed at the spoke and the chain stay, and the signals are transmitted by using a connecting wire. Thereby, it takes more time to dispose the assembly. Besides, the assembly may easily become detached from the bicycle since the signal emitter rotates with the wheel and the signal emitter and the signal receiver bear the vibration back from the ground directly.

Besides, it is usually not convenient to detach above speed meters from bicycles once they are fixed thereto and thereby the use of these speed meters is restrained.

In order to overcome above shortcomings, inventor had the motive to study and develop the present invention. After hard research and development, the inventor provides a speed meter having pedometric function that can be firmly disposed on vehicles, has simpler and fewer components, can be easily disposed or detached, and has both functions of a speed meter and a pedometer to facilitate the use.

### SUMMARY OF THE DISCLOSURE

An object of the present invention is to provide a speed meter having pedometric function comprising a gravity sensor for detecting the acceleration of a moving vehicle or the vibration produced by the human body of a person moving forward, a changeover switch, and a microprocessor for calculation. The speed meter has simple structure, so that it can be conveniently disposed at the handlebar of a vehicle or can be detached therefrom rapidly by users to carry with themselves.

Another object of the present invention is to provide a speed meter having pedometric function that comprises a gravity sensor used for detecting the acceleration of a moving vehicle and the vibration produced by the human body of a user moving forward and consequently has both functions of a speed meter and a pedometer. Thereby, it is economic for users to buy a single speed meter having pedometric function instead of a speed meter and a pedometer separately and thus is attractive to purchase as well.

In order to achieve above objects, the present invention provides a speed meter having pedometric function, which comprises a casing provided with a liquid crystal screen, a gravity sensor, and a changeover switch. A power source and a circuit board that is electrically connected with the power source and the liquid crystal screen are provided within the casing provided with the liquid crystal screen. The circuit board is provided with a microprocessor thereon. The gravity sensor is provided in the casing and connected with the microprocessor. The changeover switch is connected with the gravity sensor and the microprocessor.

Thereby, when a user drives or rides a vehicle, the forward acceleration of the vehicle can be detected by the gravity sensor and the forward speed of the vehicle can be obtained by the calculation of the microprocessor. After the changeover switch is switched when the user is going to walk or run, the up and down vibration caused by the human body of the user moving forward can be detected by the gravity sensor and the step count can be obtained by the calculation of the microprocessor and shown on the liquid crystal screen.

In practice, the gravity sensor detects the forward acceleration of a vehicle when placed horizontally and is switched to detect the up and down vibration of the human body of a user moving forward when placed vertically.

In practice, the gravity sensor can also comprise an acceleration detection unit and a vibration detection unit. The acceleration detection unit and the vibration detection unit are respectively connected with the microprocessor and the changeover switch is respectively connected with the acceleration detection unit, the vibration detection unit, and the microprocessor. Thereby, after a user switches the changeover switch, the acceleration detection unit can detect the forward acceleration of a vehicle or the vibration detection unit can detect the vibration produced by the human body moving forward.

The following detailed description, given by way of examples or embodiments, will best be understood in conjunction with the accompanying drawings.

### BRIEF DESCRIPTION OF THE DRAWINGS

FIG. 1 shows a perspective view of an embodiment of a speed meter having pedometric function of the present invention.

FIG. 2 shows a circuit block diagram of the embodiment of the speed meter having pedometric function of the present invention.

FIG. 3 is a perspective view showing that the speed meter having pedometric function of the present invention is disposed at the handlebar of a vehicle.

### DETAILED DESCRIPTION

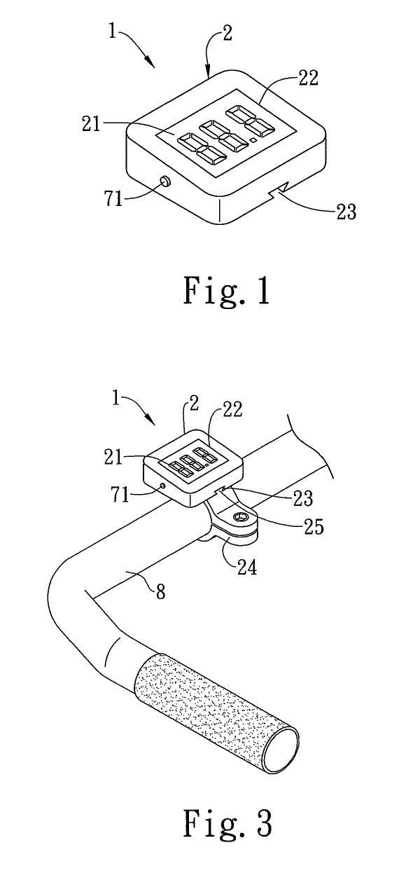

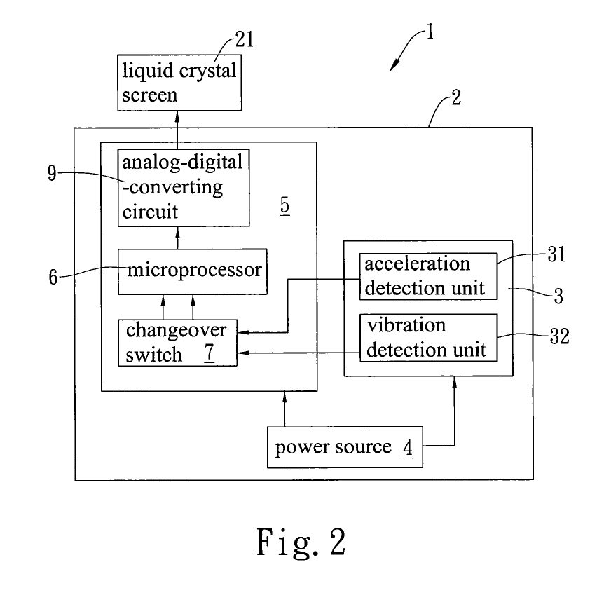

Please refer to FIGS. 1 and 2 showing a preferred embodiment of a speed meter having pedometric function according to the present invention. The speed meter having pedometric function 1 comprises a casing 2 provided with a liquid crystal screen 21, a gravity sensor 3, a power source 4, a circuit board 5, a microprocessor 6, and a changeover switch 7.

The casing 2 is roughly in rectangular shape. In practice, the casing 2 also can be in cylindrical or other three-dimensional shapes. A space is formed within the casing 2 and an opening 22 is provided on the top of the casing 2 for locating a liquid crystal screen 21. A dovetail groove is provided on the bottom of the casing 2. The dovetail groove is used as a lower engaging part 23 that can be engaged with a dovetail seat provided on the top of a connector 24 (as shown in FIG. 3). The dovetail seat is used as an upper engaging part 25. In practice, the locations of the upper and lower engaging parts 23, 25 can be interchanged with each other. Besides, the casing 2 can be screwed with the connector 24.

The gravity sensor 3, power source 4, circuit board 5, and the microprocessor 6 are respectively positioned in the space of the casing 2. The gravity sensor 3 comprises an acceleration detection unit 31 for detecting the accelerations along X-axis and Y-axis and a vibration detection unit 32 for detecting the vibration acceleration along Z-axis. The structure and action mechanism of the acceleration detection unit 31 and the vibration detection unit 32 will not described hereinafter since these have been well-known in the art. The power source 4 is at least a dry battery for providing direct current to the circuit board 5 and the gravity sensor 3. Besides, the power source also can be at least a lithium battery. The circuit board 5 is electrically connected with the liquid crystal screen 21. The microprocessor 6 is fixed on the circuit board 5 and respectively connected with the acceleration detection unit 31 and the vibration detection unit 32 of the gravity sensor 3.

The changeover switch 7 includes a control button 70 that is protruded externally from the casing 2 and connected with the acceleration detection unit 31, the vibration detection unit 32, and the microprocessor 6 to have the microprocessor 6 in communication with the acceleration detection unit 31 or have the microprocessor 6 in communication with the vibration detection unit 32. In practice, the changeover switch 7 can be an electric element that is disposed on the circuit board 5 and electrically connected with the liquid crystal screen 21 for users to switch by touching the liquid crystal screen 21.

Thereby, according to the present invention, the function of a speed meter can be performed when users connect the connector to the handlebar 8 of a three-wheeler, a motorcycle, or a bicycle, or fix it in the vehicle, to have the lower engaging part 23 on the bottom of the casing 2 engaged with the upper engaging part 25 on the top of the connector 24. When a vehicle is driven forward to produce acceleration, the acceleration detection unit 31 of the gravity sensor 3 can detect the accelerations along X-axis and Y-axis to produce electric signals. These electric signals can be conveyed to the microprocessor 6 and calculated to obtain the speed of the vehicle. The speed of the vehicle can be figured out based on the forward acceleration of the vehicle and shown on the liquid crystal screen 21 after the electric signals are transformed into digital signals via an analog-digital-converting circuit 9 provided on the circuit board 5.

The speed meter having pedometric function can be used as a pedometer after the upper and the lower engaging parts 23, 25 are detached with each other. When a user moves, the vibration acceleration along Z-axis can be detected by the vibration detection unit 32. The step count of the user can be obtained via the calculation of the microprocessor 6 and shown on the liquid crystal screen 21.

Moreover, the gravity sensor 3 can be designed to detect the X-axis and Y-axis accelerations only and the changeover switch 7 is in connection between the gravity sensor 3 and the microprocessor 6. Thereby, the forward accelerations along X-axis and Y-axis of a vehicle can be detected when the gravity sensor 3 is placed horizontally. Afterwards, the speed of the vehicle can be obtained via the calculation of the microprocessor 6. When the gravity sensor 3 is placed vertically, that is, the original X-axis and Y-axis are converted to Z-axis. The up and down vibration of the human body of a user is produced when she or he moves forward and the vibration can be detected after the changeover switch 7 is switched automatically. Afterwards, the step count of the user can be obtained via the calculation of the microprocessor 6 and shown on the liquid crystal screen 21.

Therefore, the present invention has following advantages:

1. According to the present invention, the number of components required for the speed meter having pedometric function can be reduced effectively and the speed meter can be conveniently attached to or detached from vehicles by drivers or riders themselves.

2. The speed meter according to the present invention is disposed at the handlebar of a vehicle and it is not necessary to fix a signal emitter at the spoke of a wheel and a signal receiver at one side of the chain stay. Thereby, the speed meter will not become detached from the vehicle after long-term use and the lifetime thereof is thus lengthened.

3. According to the present invention, the speed meter having pedometric function can be used as a speed meter or a pedometer in accordance with the need of a user.

4. According to the present invention, users do not have to carry two separate devices, i.e. a speed meter and a pedometer, since the functions of above two devices are incorporated into a single speed meter having pedometric function of the present invention. Besides, it will be more economical and attractive for users to buy a single speed meter having pedometric function rather than two devices of a speed meter and a pedometer.

As disclosed in the above description and attached drawings, the present invention can provide a speed meter having pedometric function, which has simple structure, can be firmly disposed at a vehicle, can be conveniently attached to or detached from a vehicle, and has both functions of a speed meter and a pedometer that can be selected conveniently by a user. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A speed meter having pedometric function, comprising:
a casing, provided with a liquid crystal screen and having a power source and a circuit board that is electrically connected with the power source and the liquid crystal screen, where the circuit board is provided with a microprocessor thereon;
a gravity sensor, provided in the casing and connected with the microprocessor; and
a changeover switch, connected with the gravity sensor and the microprocessor, wherein after a user switches the changeover switch, the forward acceleration of a vehicle or the vibration produced by the human body of a user moving forward is detected by the gravity sensor, and the forward speed of the vehicle or the step count of the user moving forward is obtained via the calculation of the microprocessor and shown on the liquid crystal screen.

2. The speed meter having pedometric function as claimed in claim 1, wherein the gravity sensor comprises an acceleration detection unit and a vibration detection unit, wherein the acceleration detection unit and the vibration detection unit are respectively connected with the microprocessor and the changeover switch is respectively connected with the acceleration detection unit, the vibration detection unit, and the microprocessor, so that after a user switches the changeover switch, the forward acceleration of a vehicle is detected by the acceleration detection unit or the vibration produced by the human body of a user moving forward is detected by the vibration detection unit, and the forward speed of the vehicle or the step count of the user moving forward is obtained via the calculation of the microprocessor and shown on the liquid crystal screen.

3. The speed meter having pedometric function as claimed in claim 2, wherein after the acceleration detection unit detects the X-axis and Y-axis forward acceleration values of a vehicle, these values are calculated by the microprocessor to obtain the forward speed of the vehicle.

4. The speed meter having pedometric function as claimed in claim 2, wherein after the vibration detection unit detects the vibration acceleration along Z-axis of a user moving forward, the step count of the user moving forward is obtained via the calculation of the microprocessor.

5. The speed meter having pedometric function as claimed in claim 1, further comprising a connector having a upper engaging part on the top thereof for being engaged with a lower engaging part provided on the bottom of the casing.
